(19) United States
(12) Patent Application Publication
(10) Pub. No.: US 2025/0235045 A1
(43) Pub. Date: Jul. 24, 2025

(54) COOKING APPLIANCE

(71) Applicant: Marek SZYMANSKI, Warrington Mall, New South Wales (AU)

(72) Inventor: Marek SZYMANSKI, Warrington Mall, New South Wales (AU)

(21) Appl. No.: 18/703,352

(22) PCT Filed: Oct. 21, 2022
(86) PCT No.: PCT/AU2022/051261

§ 371 Date: Apr. 21, 2024

(30) Foreign Application Priority Data
Oct. 21, 2021 (AU) 2021903381

(51) Int. Cl. A47J 37/06

(52) U.S. Cl. CPC A47J 37/0611

(57) ABSTRACT

A cooking appliance includes a first cooking plate and a second cooking plate, and a batter dispensing mechanism. The first cooking plate and the second cooking plate together form a cavity therebetween in the closed position thereof, at which the first and second cooking plates face each other in the vertical orientations thereof. An upper inlet for the cavity is formed by the first and second cooking plates for receiving batter into the cavity. Batter is poured by the dispensing mechanism into the inlet. The cooking plates are heated which cooks the batter and when cooked, the first cooking plate moves to an open horizontal position with the cooked product.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to an automatic cooking appliance and a method of cooking batter based food. The invention is primarily intended for cooking batter based food such as waffles and pancakes but is not limited to this use.

### 2. Description of Related Art Including Information Disclosed Under 37 CFR 1.97 and 37 CFR 1.98

Present machines for cooking waffles typically include an upper cooking plate hingedly attached to a lower horizontal cooking plate. The cooking plates both have cavity formations for forming the respective sides of the waffle to be formed, and together form a cavity therebetween in the closed position for the batter which shapes the waffle. In the open position of the plates, batter is poured onto the lower cooking plate and the upper cooking plate is lowered to face the lower cooking plate. It is common for the plates to be flipped over so that the batter fills the cavities in the (previously) upper plate. The present method is manual, complicated for the user (without following instructions), messy, often leads to spillage and waste of batter, inconsistent cooking, unhygienic, and risks the operator to burn accidents due to exposed, high temperature hotplates.

Also, the cooking surfaces should be non-stick. One option is cast iron, which requires high maintenance, use of additional oils or fats and careful and frequent cleaning. Another option is to use Teflon-like, non-stick coating. This type of coating is a subject to relatively quick wear and tear. In many such devices, the cooking plates are not replaceable which renders the whole device unusable. In other cases, the plates can be replaced but the process is often cumbersome, complicated, and requires tools and detailed instructions.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a cooking appliance comprising:
a first cooking plate and a second cooking plate each having a food forming side, the first cooking plate and the second cooking plate being configurable between:
an open position at which the food forming sides are disposed away from each other, and
a closed position at which the food forming sides are disposed to be adjacent and facing each other to form a cooking cavity therebetween, the first and second cooking plates being generally vertical in the closed position and defining an upper inlet for the cooking cavity,
heating means for heating the first cooking plate and the second cooking plate, and a liquid dispensing mechanism for dispensing liquid-based food into the cooking cavity via the upper inlet.

In one embodiment, each food forming side of the first cooking plate and the second cooking plate comprises a raised peripheral edge to form a shallow cavity thereon, the peripheral edges of the first and second cooking plates sealing with each other to form the cooking cavity in the closed position.

In another embodiment, the upper inlet for the cooking cavity is formed by shaped halffunnel formations at distal portions of the first and second cooking plates.

In another embodiment, the heating means comprises a first heating plate and a second heating plate to which the first cooking plate and the second cooking plate are respectively attached.

In another embodiment, each heating plate comprises an inner face for engaging its respective cooking plate and an embedded heating element for heating the inner face.

In another embodiment, the first heating plate and the second heating plate each comprises an attachment mechanism for attaching the respective cooking plate thereon in a removable manner.

In another embodiment, the first cooking plate and the second cooking plate each have a connection side opposite to the food forming side, the connection sides having spaced attachment posts, each heating plate comprising spaced apertures which receives the attachment posts of the respective cooking plate therethrough, wherein the attachment mechanism comprises retaining clips which are lockable with the attachment posts.

In another embodiment, the attachment posts each include a side recess, and the attachment mechanism for each heating plate comprises a rotatable plate at the outer face of the heating plate, the rotatable plate having a respective curved elongated slot for each attachment post through which the respective post extends through, and where a biased retaining spring clip is disposed across each elongated slot, wherein the rotatable plate is movable between an unlocked position and a locked position at which the respective retaining clip engages the side recess of the respective attachment post.

In another embodiment, each clip comprises a front retaining bar and a rear portion which is pivotably mounted to the rotatable plate such that the retaining bar can move from a disengaged position close to the rotatable plate to an engaged position in the side recess of the attachment post.

In another embodiment, the retaining bars are disposed to face the side recess of the respective attachment post, and when the rotatable plate is rotated from the unlocked position, the retaining bar of the retaining clips hook into the side recess, and with continuing rotation of the rotatable plate, the clips are compressed to a maximum compression in their vertical position relative to the rotatable plate, then with further rotation of the rotatable plate the clips past the vertical position relative to the rotatable plate the clips expand back and are locked in that position in the respective side recess being the locked position of the rotatable plate.

In another embodiment, the retaining clips exert an outward force to the attachment posts which spring biases the cooking plates to the respective heating plate.

In another embodiment, the heating plate includes stationary handle tabs and the rotatable plate includes a movement handle tab which disposed between the stationary tabs to assist with rotation of the rotatable plate between the unlocked and locked rotation positions of the rotatable plate.

In another embodiment, the second heating plate is held stationary in the vertical position and the first heating plate is pivotably movable between an open generally horizontal position and a closed vertical position.

In another embodiment, the cooking appliance of further comprises a scale to which the first cooking plate and the second cooking plate are mounted, wherein the required amount of liquid-based food in the cavity is measured by the weight measured on the scale.

In another embodiment, the cooking appliance further comprises a lower stand having the scale, an upper stand vertically spaced above the lower stand via posts, wherein the liquid dispensing mechanism is disposed in the upper stand.

In another embodiment, the liquid dispensing mechanism comprises a platform for receiving a bag having the liquid-based food therein, with an outlet nozzle of the bag being directed to an outlet of the dispensing mechanism, the liquid dispensing mechanism comprises a roller which engages the bag for pushing out the liquid-based food into the upper inlet.

In another embodiment, the cooking process is timed via a timer and when finished, the first cooking plate moves to the open position thereof with the cooked food product.

In another embodiment, the cooking appliance additionally includes an optical sensor to detect a stream of the liquid-based food being dispensed and a control processor can alter the speed of dispensing as required.

In another embodiment, a scale is mounted under the platform for receiving the bag with the batter to measure how much batter is removed from the bag.

In another embodiment, the cooking appliance further includes a proximity optical sensor to check the liquid level in the cooking cavity as it is being filled.

In another embodiment, one of the first cooking plate or the second cooking plate has a higher cooking temperature than the other cooking plate.

In another embodiment, one of the first cooking plate or the second cooking plate has a smaller cooking surface area than the other cooking plate.

In another embodiment, the heat provided by the heating means to the respective cooking plates is respectively adjustable.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a left side perspective view of a cooking appliance in accordance with a preferred embodiment of the present invention with the first cooking plate in the open position thereof.

FIG. 2 is a left side perspective view of the cooking appliance with the posts and batter dispensing mechanism omitted for illustration purposes.

FIG. 3 is a right side perspective view of the cooking appliance similar to FIG. 2.

FIG. 4 is a right side perspective view of the cooking plates, the other parts of the cooking appliance being omitted for illustration purposes.

FIG. 5 is a right side perspective view with the second cooking plate removed from the heating plate thereof to show the features of the heating plate.

FIG. 6 is a rear perspective view of the configuration of FIG. 5 showing the heating plate.

FIG. 7 is a left side perspective view showing the batter dispensing mechanism for the cooking appliance.

FIG. 8 is a side view showing the first cooking plate moving from the open generally horizontal position towards the closed vertical position.

FIG. 9 is a side view showing the first cooking plate in the closed vertical position thereof together with the vertical second cooking plate, together defining a forming cavity therebetween.

FIG. 10 is a side view showing batter being dispensed into the forming cavity of the first and second cooking plates in the cooking position thereof.

FIG. 11 is a side view showing cooking of the batter between the first and second cooking plates.

FIG. 12 is a side perspective view showing the first plate moved to the open horizontal position thereof for removal of the formed waffle.

FIG. 13 is a side perspective view showing the formation channels in one of the cooking plates.

FIG. 14 is an exploded view showing (a) the rear side of a cooking plate with mounting posts, and (b) the rear side of a heating plate with a removable mount means for the cooking plate, (c) is a rear perspective view and (d) is a front perspective view showing alignment of the mounting posts to the heating plate apertures;

FIG. 15 is a rear perspective view showing insertion of the mounting posts into apertures of the heating plate.

FIG. 16 is a rear perspective view showing the mounting posts of the cooking plate at a locked position relative to the heating plate.

FIG. 17 is a front perspective view showing side cover panels and a front access door for the cooking appliance with the door in an open position.

FIG. 18 is a front perspective view showing the door in the closed position.

### DETAILED DESCRIPTION OF THE INVENTION

It should be noted in the following description that like or the same reference numerals in different embodiments denote the same or similar features.

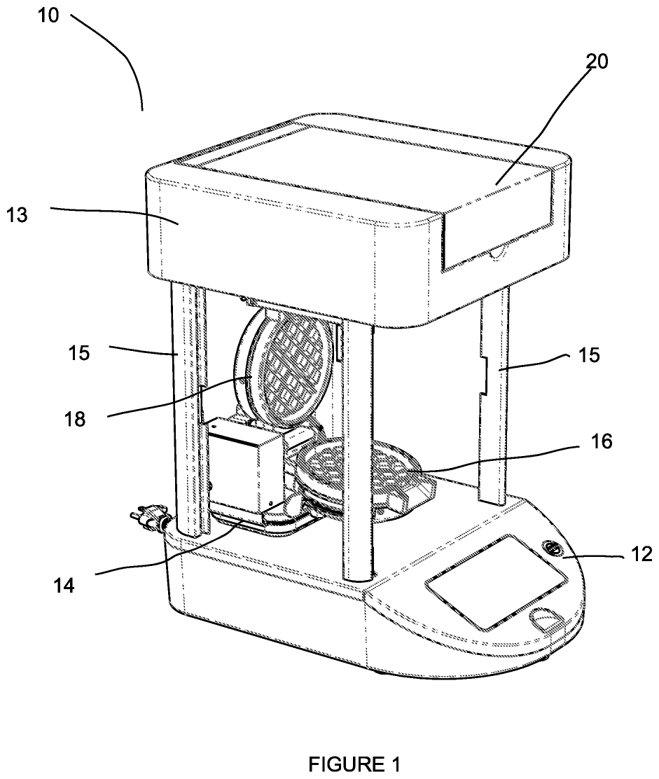

FIGS. 1 to 6 show a cooking appliance 10 according to a preferred embodiment of the present invention. The cooking appliance 10 comprises a lower stand 12 having a scale 14, a first cooking plate 16 and a second cooking plate 18 disposed on the lower stand 12, an upper stand 13 vertically spaced above the lower stand 12 via posts 15, and a batter dispensing mechanism 20 in the upper stand 13 for dispensing batter into the cooking plates 16 and 18 in use.

The first cooking plate 16 and the second cooking plate 18 are disposed above the lower stand 12 and connected to the scale 14, and the batter dispensing mechanism 20 is held by the upper stand 13 above the first and second cooking plates 16 and 18.

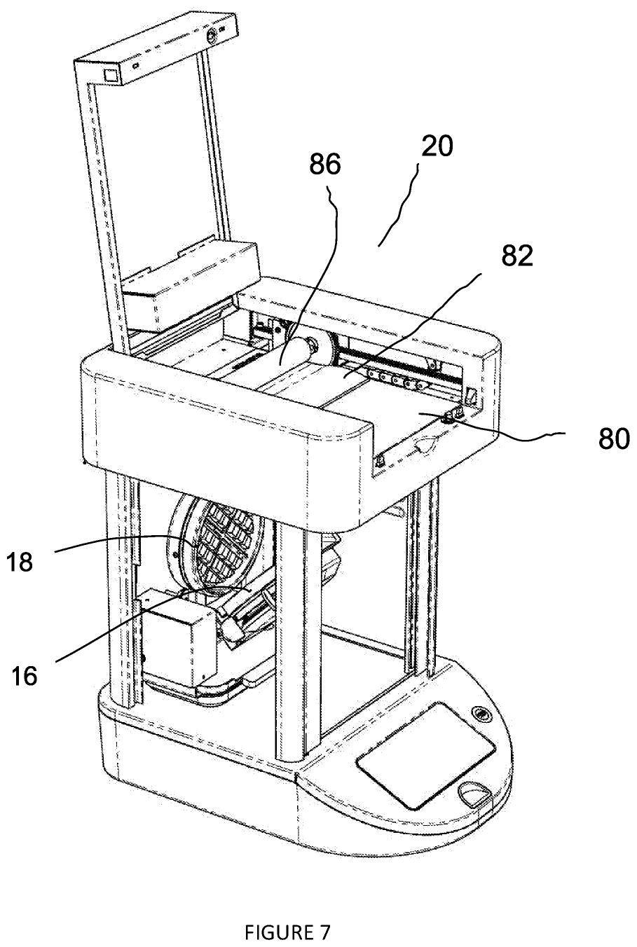

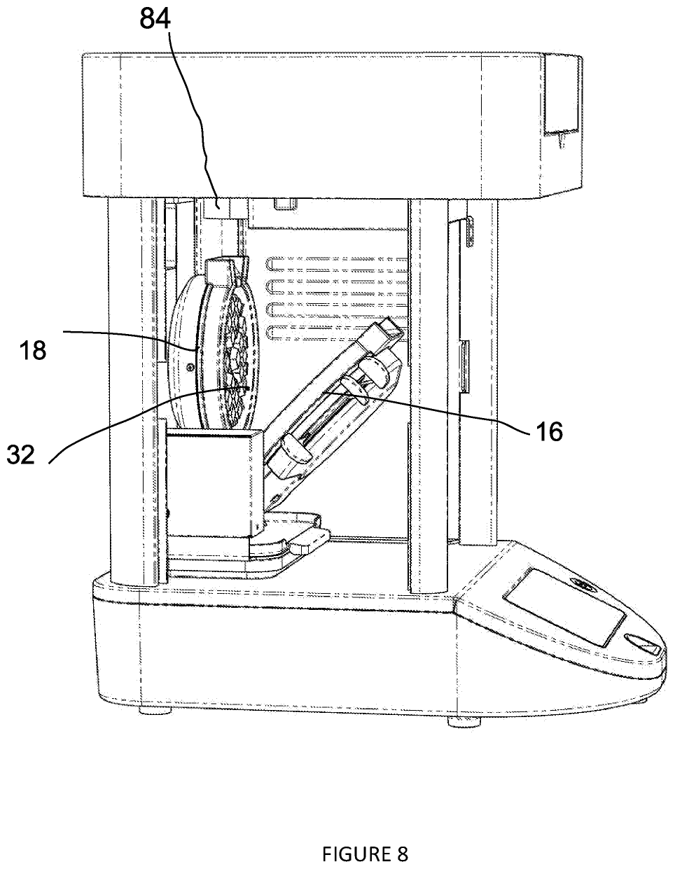

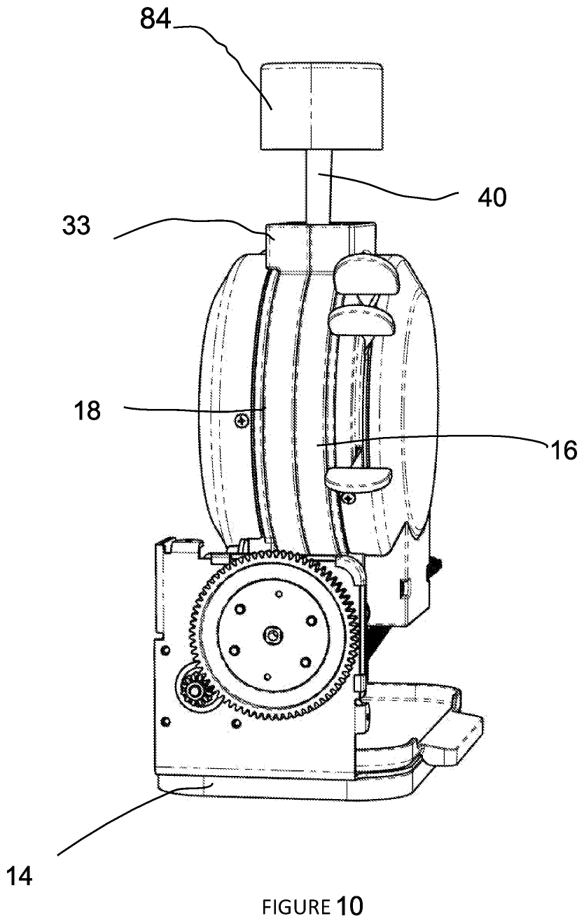

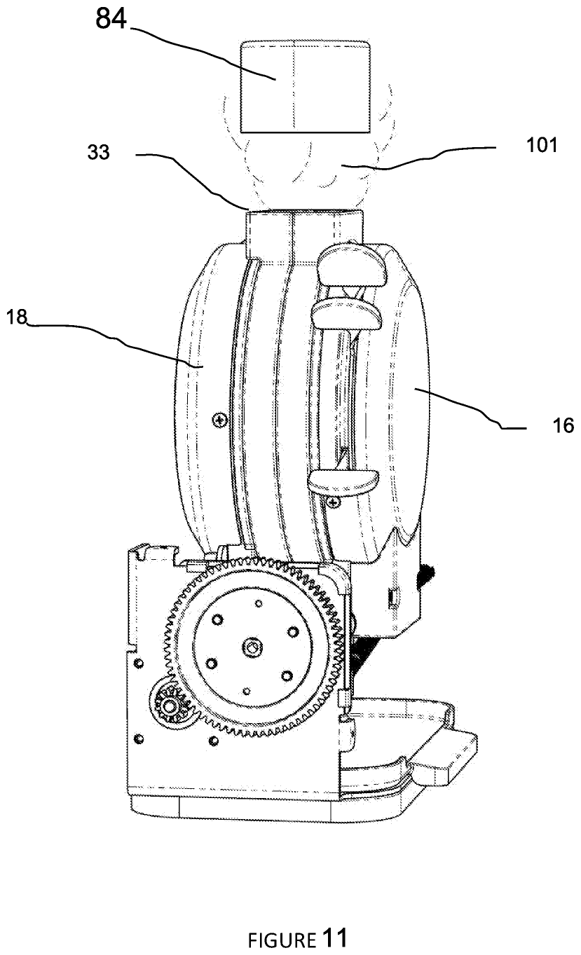

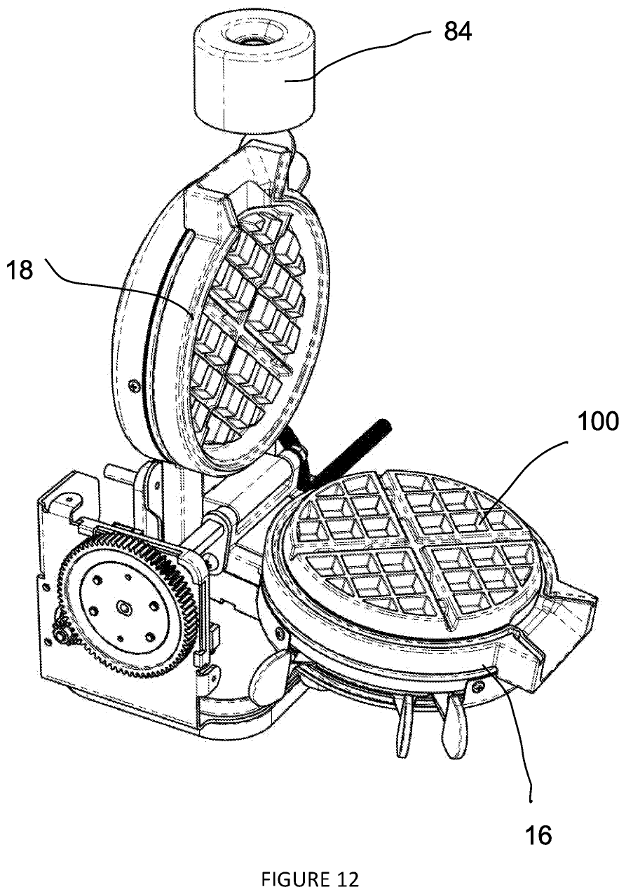

Referring briefly to FIGS. 7 to 9, the first cooking plate 16 and the second cooking plate 18 together form a cavity 32 therebetween in the closed position thereof, at which the first and second cooking plates 16 and 18 face each other in the vertical orientations thereof. An upper inlet 33 for the cavity 32 is formed by the first and second cooking plates 16 and 18 for receiving batter 40 into the cavity 32. Batter 40 (see FIG. 10) is poured by the dispensing mechanism 20 into the inlet 33 with the required amount of batter in the cavity 32 being measured by the scale 14. The cooking plates 16 and 18 are heated which cooks the batter 40 with steam 101 (FIG. 11) escaping via the inlet 33, the cooked batter being formed into a waffle 100 (FIG. 12) and when cooked (timed via a timer, or detection of the temperature variance), the first cooking plate 16 moves to an open horizontal position (FIG. 12) with the cooked waffle product 100. Further details on each component of the cooking appliance 10 will now be described.

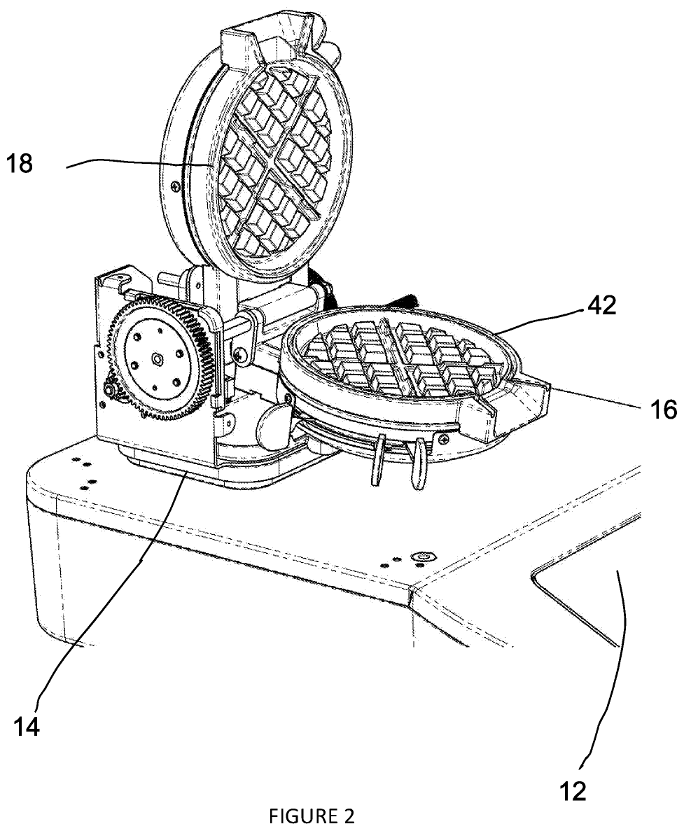

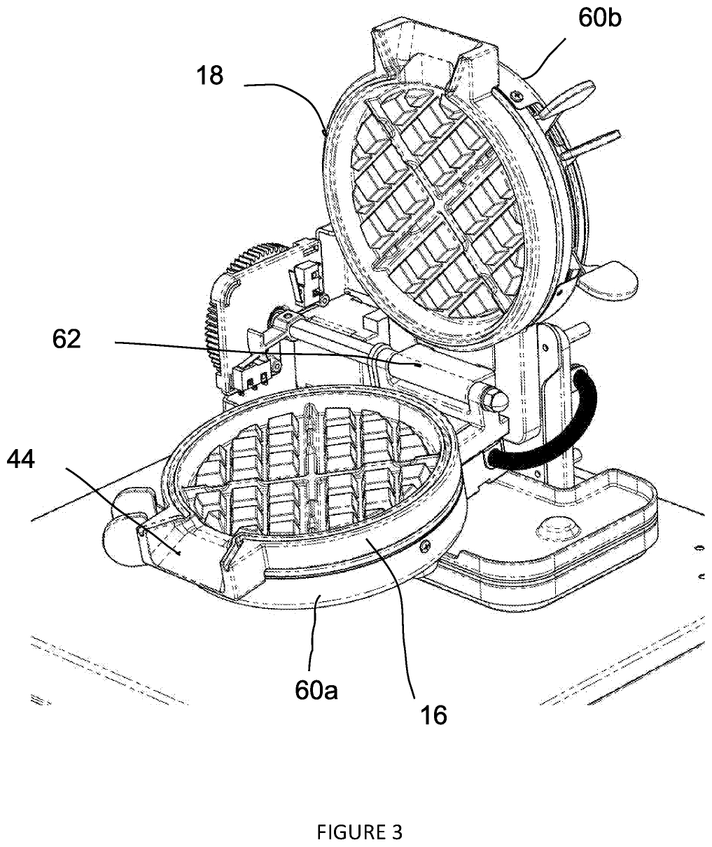

Referring to FIGS. 2 and 3, the first cooking plate 16 and the second cooking plate 18 in the example shown are both generally disc shaped in the example and are generally mirror images of each other. The cooking plates however can be formed in any other shape, for example square, oval, or a fancy character shape. The cooking plates can also have different forming patterns, for example grooves on one cooking plate and a flat shape on the other cooking plate.

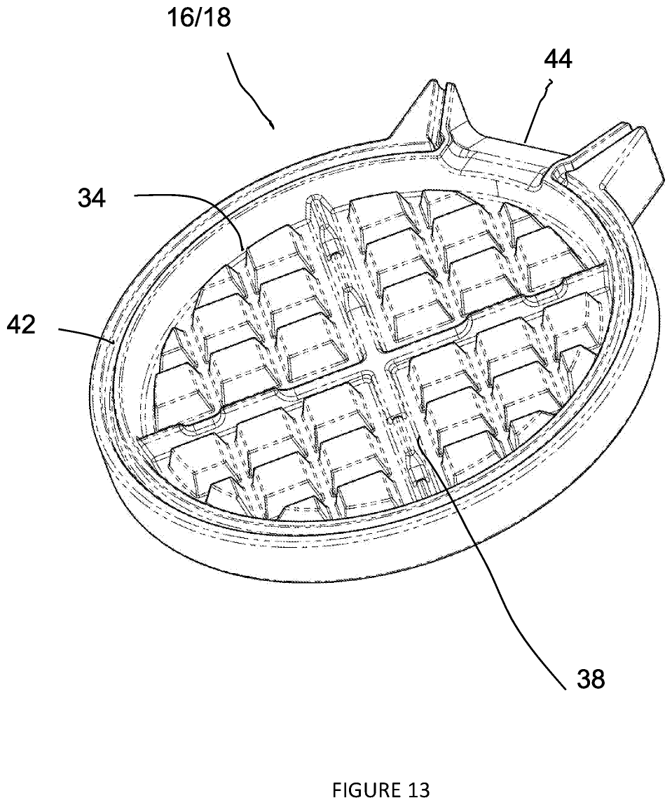

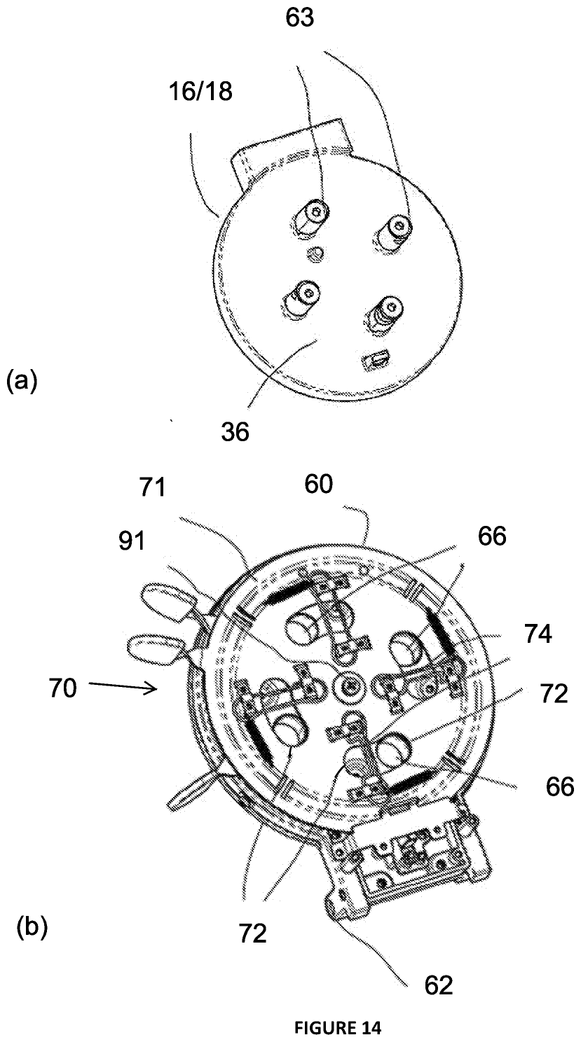

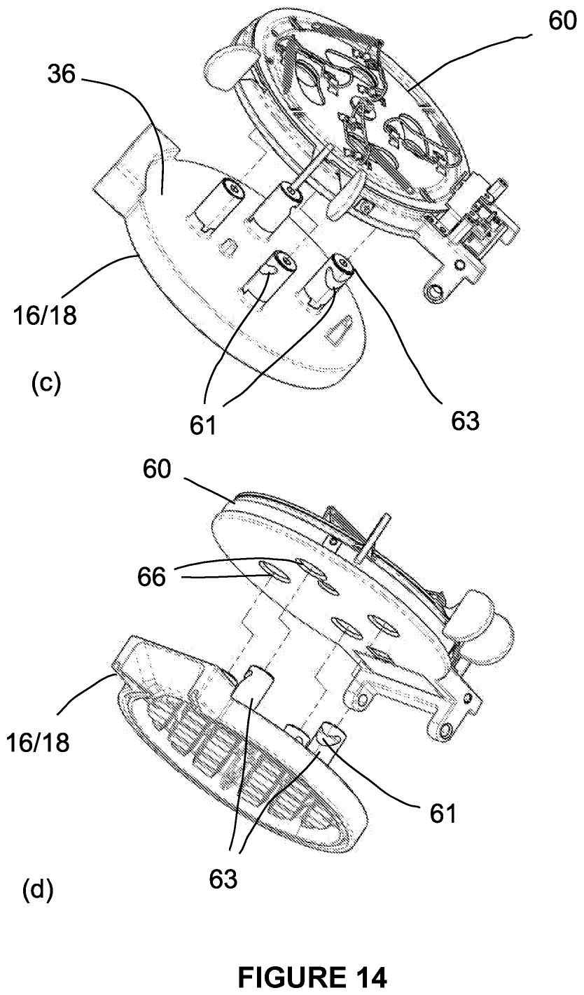

Referring to FIGS. 13 and 14, each cooking plate 16/18 has a forming side 34 and an opposite connection side 36 (FIG. 14). The cooking plates 16 and 18 are both heat conductive (metal in the example) and are connected to respective heating plates 60 (FIGS. 3 and 14) in a removable manner. The forming side 34 of each cooking plate 16 and 18 has formations 38 for forming the respective side of the waffle to be formed. In this embodiment, the formations 38 are in the shape of a grid cavity being the typical face shape of a waffle. The cooking appliance 10 provides for the cooking plates 16 and 18 to be easily removable from their respective heating plates 60 and interchangeable with other cooking plates with different formations 38 for forming waffles with different face shapes or other batter based products such as pancakes, omelettes and others. The cooking plates 16 and 18 being easily replaceable allows them to be easily cleaned and replaced as needed—for example if their non-stick surface is damaged or if the user wants to use plates with a different forming pattern.

The forming side 34 of each cooking plate 16 and 18 has a peripheral edge 42 raised from the formations 38 to form a shallow cavity thereon. A distal portion of the peripheral edge 42 is formed into a half-funnel formation 44. The half-funnel formation 44 is opposite to the hinge connector points 62 of the heating plate 60. In the closed position, the half-funnel formations 44 of the first and second cooking plates 16 and 18 together form the upper inlet 33, and the peripheral edges 42 of the first and second cooking plates 16 and 18 seal with each other to form the closed cooking cavity 32. The cavity 32 has the shape and volume of the desired food product to be cooked and formed, with the upper inlet 33 guiding the batter 40 into the cavity 32.

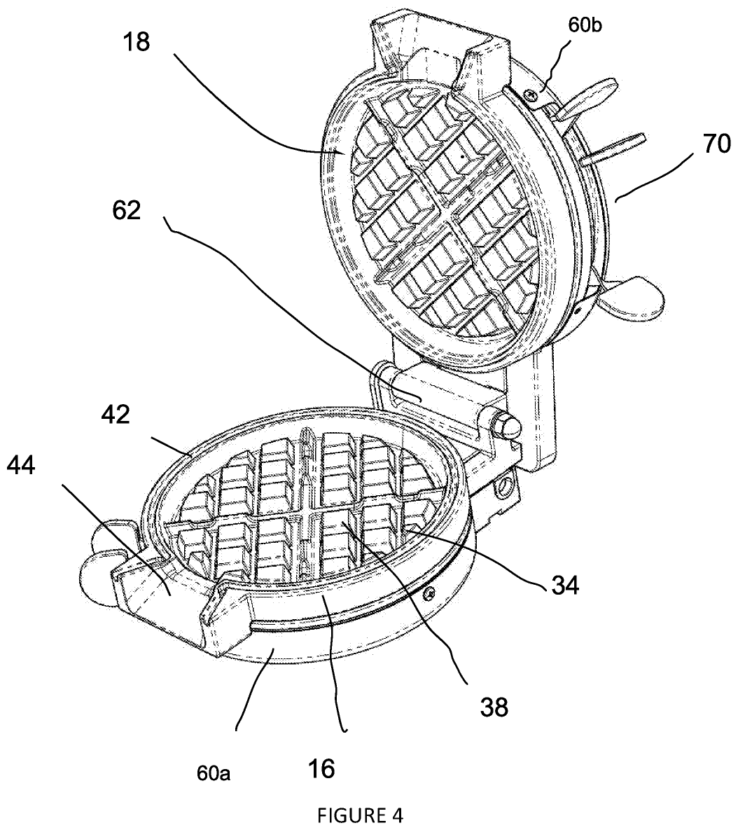

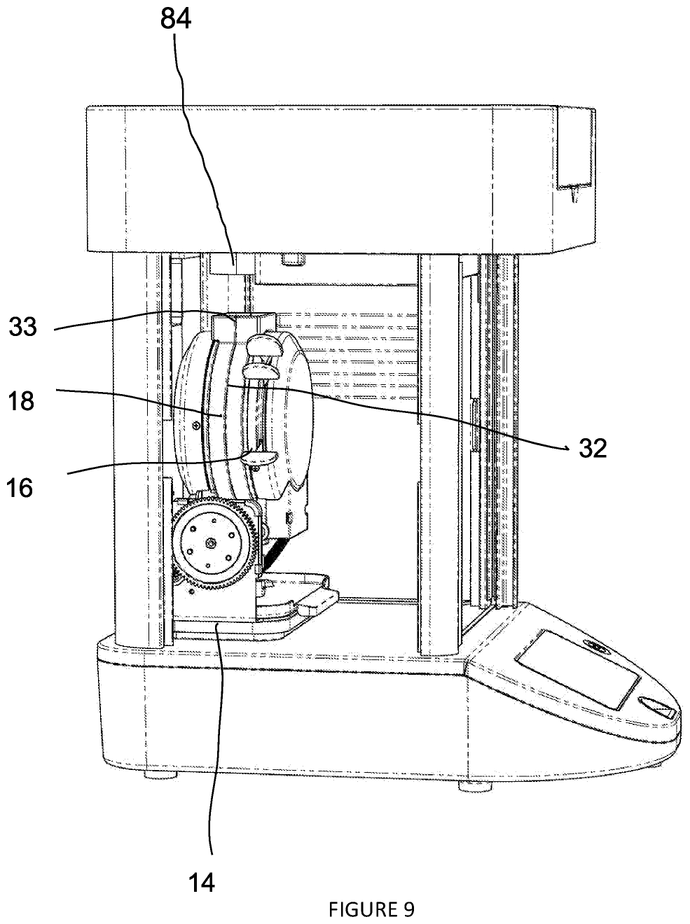

Referring to FIGS. 4 to 6, the cooking appliance 10 comprises first and second heating plates 60a and 60b to which the first and second cooking plates 16 and 18 are respectively attachable in a removable manner. The first and second heating plates 60a and 60b are pivotably attached to each other at a pivot connection 62. In the embodiment shown, the second heating plate 60b is held stationary in the vertical position and the first heating plate 60a is pivotably movable between an open generally horizontal position as shown in FIGS. 1 to 6 and a closed vertical position as shown in FIGS. 9 to 11. Preferably, the first heating plate 60a is angled slightly downwardly in the fully open position thereof for presenting the cooked product 100 to the user.

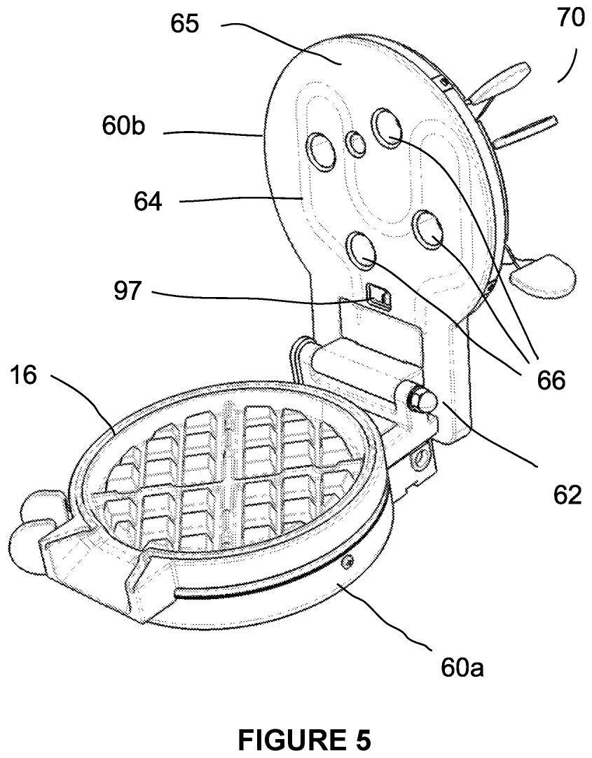

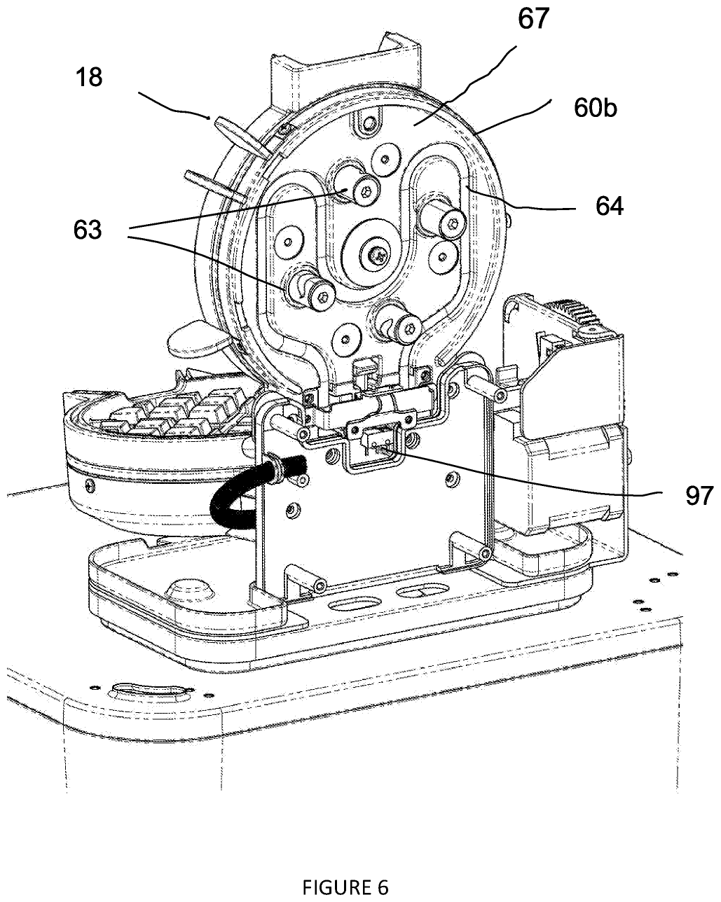

As shown in FIGS. 5 and 6, each heating plate 60 comprises a heating element 64 embedded therein which heats an inner face 65 of the heating plate 60 for engaging its respective cooking plate 16 or 18, and an attachment mechanism 70 at the opposite outer face 67 thereof. The heating element 64 is disposed within a shaped groove formed within the heating plate 60 for heating the flat inner face 65. The inner face 65 is flat to engage and fully contact the respective cooking plate 16/18. Each heating plate 60 further comprises spaced apertures 66 (FIG. 14) which receives the attachment posts 63 of the respective cooking plate 16/18 therethrough.

Referring to FIGS. 14 to 16, the connection side 36 of each cooking plate 16/18 is flat and includes spaced attachment posts 63. The attachment posts 63 each include a side recess 61 formed at a side portion thereof, the recess 61 angled generally upwardly in the respective attachment post 63. The recesses 61 in the attachment posts 63 thus provide the attachment posts 63 with a generally downward hook shape. When the attachment posts 63 of the cooking plate 16/18 are inserted into the apertures 66 of its respective heating plate 60, the attachment posts 63 and their side recess 61 extend outwardly of the outer face 67 of the heating plate 60.

The quick latch attachment mechanism 70 comprises a rotatable plate 71 at the outer face 67 of the heating plate 60, the rotatable plate 71 being rotatable about a central point 91 between a locked position and unlocked position relative to the heating plate 60. The rotatable plate 71 has curved elongated slots 72 which are shaped into an arc having the rotation point 91 as their centre. The rotatable plate 71 has a respective curved elongated slot 72 for each attachment post 63, through which the respective post 63 extends through (being four slots 72 for four posts 63 in the example shown).

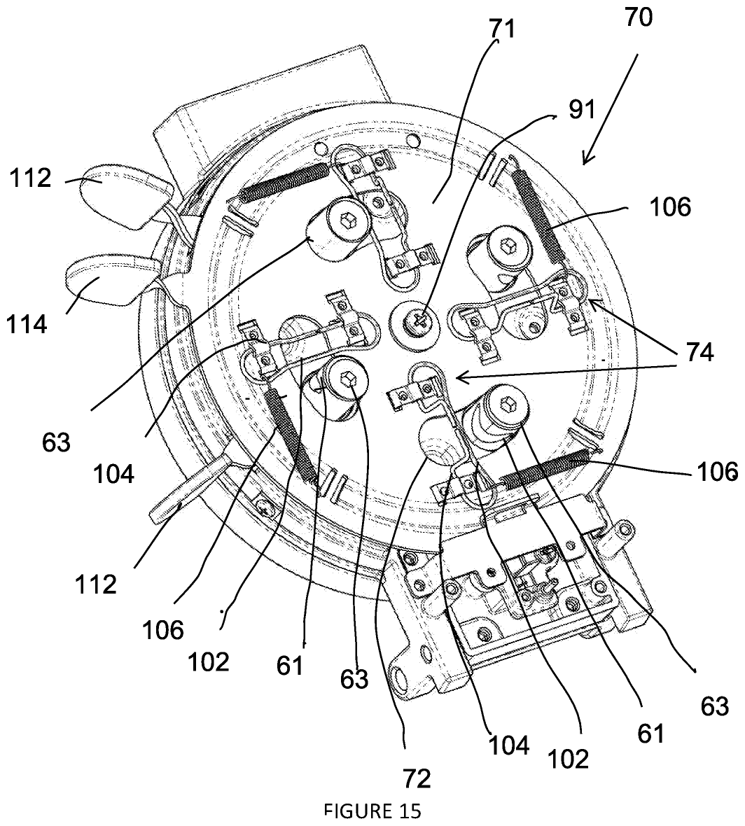

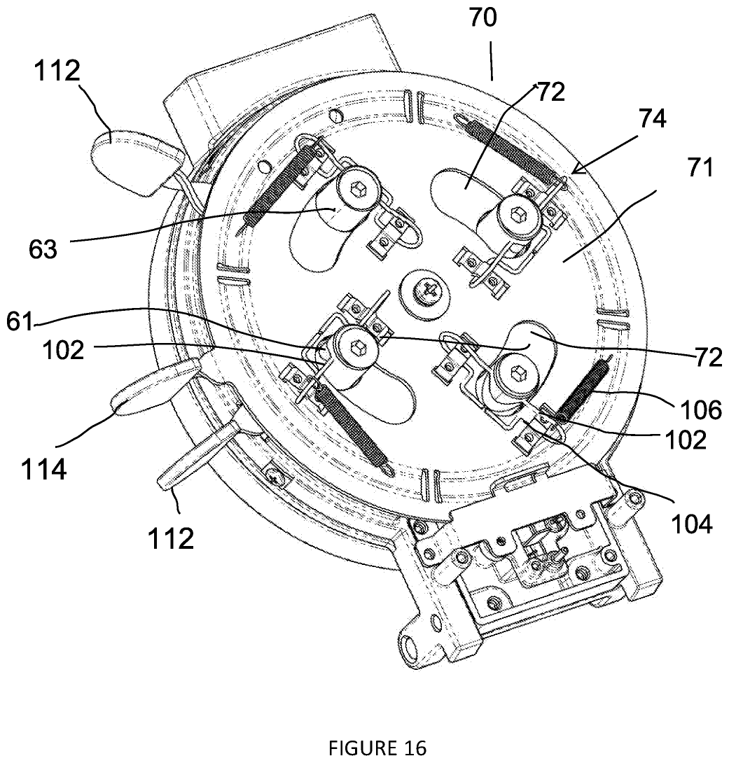

Referring to FIG. 15, the attachment mechanism 70 further includes a biased retaining spring clip 74 for each slot 72. Each spring clip 74 comprises a front retaining bar 102 and a rear portion 104 which is pivotably mounted to the rotatable plate 71 such that the retaining bar 102 can move from a disengaged position close to the rotatable plate 71 (FIG. 15) to a generally upward engaged position away from the rotatable plate 71 (FIG. 16). A respective spring 106 biases the retaining bar 102 to the disengaged position.

The retaining bars 102 are disposed to face the side recess 61 of the respective attachment post 63. When the rotatable plate 71 is rotated from the unlocked position thereof, the retaining bar 102 hook into the side recess 61, and with continuing rotation of the rotatable plate 71, the clips 74 are bent/compressed (maximum compression) in their vertical position (90°) relative to the rotatable plate 71, then with further rotation of the rotatable plate 71 the clips relax past 90° relative to the rotatable plate 71 and expand back and are locked in that position in the respective side recess 61 (FIG. 16).

This defines the locked position of the rotatable plate 71 which locks the cooking plate 16/18 to the respective heating plate 60. Further, the retaining clips 74 exert an outward force to the attachment posts 63 which spring biases the cooking plate 16/18 to the heating plate 60. This ensures optimal contact for heat transfer between the cooking plate 16/18 and the respective heating plate 60. To disengage the retaining clips 74 from the side recesses 61, the rotatable plate 71 is rotated in the other direction. This disengages the retaining clips 74 (after overcoming the initial spring resistance) from the posts 63 which allows removal of the respective cooking plate 16/18.

The heating plate 60 includes stationary handle tabs 112 and the rotatable plate 71 includes a movement handle tab 114 which disposed between the stationary tabs 112 to assist with rotation of the rotatable plate 71. The handle tabs 112 and 114 enable easy engaging of the retaining clips 41 as some force is required to overcome the retaining clip 74 spring force. The user can move the movement handle tab 114 relative to one of the stationary handle tabs 112 with just two fingers, without the need to hold the whole device. FIGS. 15 and 16 show the position of the movement handle tab 114 between the unlocked and locked rotation positions of the rotatable plate 71.

The attachment mechanism 70 urges the heating plate 16/18 towards the heating element 64 and provides firm attachment between the heating plate 16/18 and the heating plate 60 for efficient heat transfer. The attachment mechanism 70 also provides easy removable attachment of the cooking plates 16 and 18 to the heating plates 60 which allows quick swap of cooking plates as desired.

The heating plates 60 are disposed such that they provide the relative open and closed positions between the first and second heating plates 16 and 18 when the cooking plates 16/18 are attached to the heating plates 60. In the open position, the second heating plate 18 is stationary in the vertical orientation thereof and the first heating plate 16 is disposed in a generally horizontal orientation thereof.

In the closed position, the first heating plate 16 is moved by the heating plate 60a to a vertical orientation at which the forming side 34 of the cooking plates 16 and 18 face each other. That is, the peripheral edges 42 of the cooking plates 16 and 18 engage and fluidly seal with each other to form the cooking cavity 32, with the half-funnel formations 44 together forming the inlet 33. In this regard, the peripheral edges 42 can be correspondingly shaped to provide the required fluid seal, such as by forming one edge 42 as a male member formation and the other edge 42 as a female channel formation for receiving the other edge 42.

In the closed position, the inlet 33 is positioned at the upper portion of the cavity 32 ready to receive batter from the batter dispensing mechanism 20. Referring to FIG. 7, the batter dispensing mechanism 20 in this embodiment comprises a platform 80 for receiving a bag 82 having the batter therein, with an outlet nozzle of the bag 82 being directed to an outlet 84 of the dispensing mechanism 20. The batter dispensing mechanism 20 comprises a roller 86 which engages the bag 82 for pushing out the batter 40 into the inlet 33 (FIG. 9). The outlet nozzle of the bag 82 also includes a one-way valve to seal the batter mix in the bag against bacteria or air and to prevent dripping or spillage. The use of a bag 82 and roller 86 provides the advantage of no cleaning or sanitation of dispensing equipment is required.

The liquid dispensing mechanism for example can be one of the embodiments described in the specification of Australian Patent AU2008247299 which is incorporated herein by reference. The required amount of batter 40 is measured by the scale 14. The cooking process then starts and timed via a timer. Once finished, the first cooking plate 16 moves to the open position thereof with the cooked waffle 100 (FIG. 12).

The entire cooking process is automated in the cooking appliance 10 via a control processor 105. The user simply presses a button or triggers a sensor to start the cooking process. The cooking plates 16/18 are heated or pre-heated by the heating plates 60. The first heating plate 60a is moved by a stepper motor (or any suitable motor controlled by position/end switches) to move the first cooking plate 16 to the closed vertical position thereof to form the cavity 32. Dispensing of the batter via the batter dispensing mechanism 20 is also performed by an electric motor operating the roller 86. The cooking appliance 10 additionally includes an optical sensor 110 to detect the batter stream being dispensed and the control processor 105 can alter the speed of dispensing as required. The optical sensor 110 detects the width of the batter stream being dispensed and the control processor can increase the speed of the motor to increase the thickness of the batter stream or decrease the speed of the motor to decrease the thickness of the batter stream. This feature is advantageous to provide a quick start to the batter being dispensed, consistent flow in the middle of the dispensing, and then slow finish of the dispensing step to avoid wastage and provide fast consistent dispensing. The control processor 105 monitors the scale 14 for the correct amount of batter to be received in the cavity 32. Once received, the control processor stops the roller 86. The control processor then monitors the cooking time, and moves the first cooking plate 16 to the open position thereof to present the cooked product to the user.

The present invention thus provides a cooking appliance with vertical cooking plates for waffle and other batter-based products which avoid the need for the cooking plates to be turned. The cooking appliance also provides a neat mess free pouring of batter into the cooking plates compared to the prior art. The cooking appliance is hygienic as the process is automated and the user does not have to touch any portion of the cooking elements, or handle the batter. Further, wastage of batter is avoided as all dispensed batter is received in the cooking cavity. The cooking plates are also quickly interchangeable to provide other shaped cooking faces, such as logos or characters and for easy cleaning and replacement.

The invention has been developed primarily for cooking batter-based food products such as cakes, crepes, pancakes and waffles, but can also be used for liquid-based good such as egg-based products including quiches, omelettes and cooked eggs.

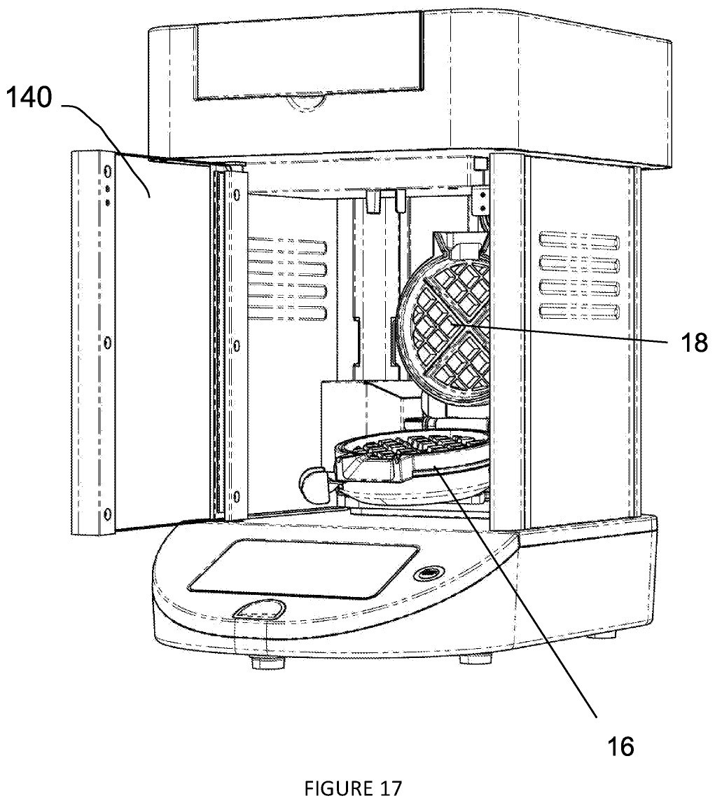

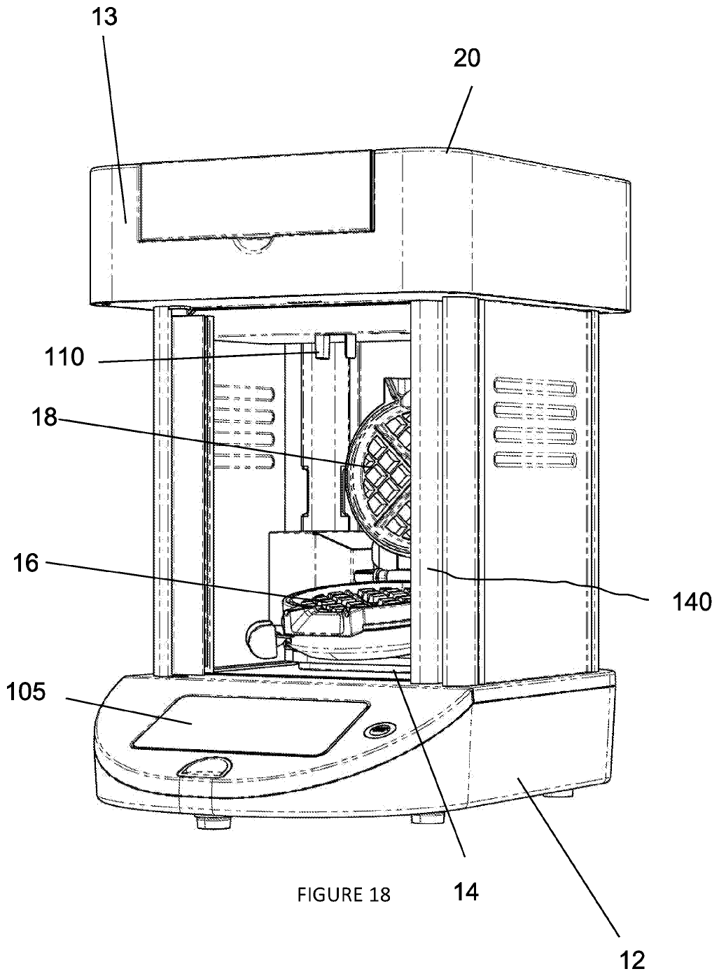

Although a preferred embodiment of the present invention has been described, it will be apparent to skilled persons that modifications can be made to the embodiment shown. Such additional features include:
a. Waffle debris detection-if there is any debris left on the cooking plates the scale 14 will detect the debris and notify the user to collect/clean;
b. Sensors 97 (FIGS. 5 and 6) to detect if the cooking plates are installed and inserted correctly
c. Automatic door 140 for user safety (shown in FIGS. 17 and 18). The door 140 can be used as a safety in that cooking will not commence until the door is closed.
d. Crumb tray for easy cleaning
e. Infrared sensor for contactless operation to initiate the cooking process
f. Sensor detecting stream coming from the bag to control the speed of dispensing-control motor fast forward when no mix is coming from the bag at the beginning of squeeze to initiate flow, provide consistent flow during dispensing, then slow flow at the end of the dispensing, to optimise the precision of amount dispensed. This is practical to save time of making waffle.
g. The vertical second cooking plate having a slightly higher cooking temperature than the movable first cooking plate. With the cooking temperatures being at about 180° C. to 210° C., the vertical first cooking plate can be set at 5° C. to 10° C. hotter than the movable first cooking plate. With this feature, the cooked product is less likely to stick to the vertical plate and more likely to move with the bottom plate for the customer to access.
h. The cooking temperature of the cooking plates being adjustable—this will allow custom cooking of waffles depending on preference as well as adjustment of the cooking plate temperature depending on the product being cooked (egg, crepes, pancakes, etc.). As the cooked product is less likely to stick to the higher temperature cooking plate, this can also allow the user to select which cooking plate for the cooked product to remain with in the open position of the cooking plates.
i. The vertical second cooking plate having less cooking surface than the movable first cooking plate. This feature can be provided for example by changing the pyramid pattern in the cooking plates such that the vertical cooking plate has shallower pyramid sides. With this feature, the cooked product is less likely to stick to the vertical plate and more likely to move with the bottom plate for the customer to access.
j. Measurement of the amount of liquid batter mix to fill the cavity 32 could be also achieved by:
   i. A scale mounted under the platform 80 for receiving the bag 82 with the batter therein, to measure how much batter is removed from the bag 82, instead of dispensed
   ii. A proximity/optical sensor 110 to check the liquid level in the cavity 32 as it is being filled
   iii. A flow meter can be used in the traditional peristaltic or gear pumps.

I claim:

1. A cooking appliance, comprising:
a first cooking plate and a second cooking plate, each cooking plate having a food forming side, the first cooking plate and the second cooking plate being configurable between:
an open position at which the food forming sides are disposed away from each other, and
a closed position at which the food forming sides are disposed to be adjacent and facing each other to form a cooking cavity therebetween, the first and second cooking plates being generally vertical in the closed position and defining an upper inlet for the cooking cavity,
heating means for the first cooking plate and the second cooking plate, and
a liquid dispensing mechanism for liquid-based food into the cooking cavity via the upper inlet.

2. The cooking appliance of claim 1, wherein each food forming side of the first cooking plate and the second cooking plate comprises a raised peripheral edge to form a shallow cavity thereon, the peripheral edges of the first and second cooking plates sealing with each other to form the cooking cavity in the closed position.

3. The cooking appliance of claim 1, wherein the upper inlet for the cooking cavity is formed by shaped half-funnel formations at distal portions of the first and second cooking plates.

4. The cooking appliance of claim 1, wherein the heating means comprises a first heating plate and a second heating plate to which the first cooking plate and the second cooking plate are respectively attached.

5. (canceled)

6. The cooking appliance of claim 4, wherein each heating plate comprises an inner face for engaging its respective cooking plate and an embedded heating element for heating the inner face, and wherein the first heating plate and the second heating plate each comprise an attachment mechanism for attaching the respective cooking plate thereon in a removable manner.

7. The cooking appliance of claim 6, wherein the first cooking plate and the second cooking plate each have a connection side opposite to the food forming side, the connection sides having spaced attachment posts, each heating plate comprising spaced apertures which receives the attachment posts of the respective cooking plate therethrough, and
wherein the attachment mechanism comprises retaining clips which are lockable with the attachment posts.

8. The cooking appliance of claim 7, wherein the attachment posts each include a side recess, and the attachment mechanism for each heating plate comprises a rotatable plate at the outer face of the heating plate, the rotatable plate having a respective curved elongated slot for each attachment post through which the respective post extends through,
wherein a biased retaining spring clip is disposed across each elongated slot, and
wherein the rotatable plate is movable between an unlocked position and a locked position at which the respective retaining clip engages the side recess of the respective attachment post.

9. The cooking appliance of claim 8, wherein each clip comprises a front retaining bar and a rear portion which is pivotably mounted to the rotatable plate such that the retaining bar can move from a disengaged position close to the rotatable plate to an engaged position in the side recess of the attachment post.

10. The cooking appliance of claim 9, wherein the retaining bars are disposed to face the side recess of the respective attachment post, and when the rotatable plate is rotated from the unlocked position, the retaining bar of the retaining clips hook into the side recess, and with continuing rotation of the rotatable plate, the clips are compressed to a maximum compression in their vertical position relative to the rotatable plate, then with further rotation of the rotatable plate the clips past the vertical position relative to the rotatable plate the clips expand back and are locked in that position in the respective side recess being the locked position of the rotatable plate, and
wherein the retaining clips exert an outward force to the attachment posts which spring biases the cooking plates to the respective heating plate for efficient heat transfer.

11. (canceled)

12. The cooking appliance of claim 10, wherein the heating plate comprises stationary handle tabs, and wherein the rotatable plate comprises a movement handle tab which is disposed between the stationary tabs to assist with rotation of the rotatable plate between the unlocked and locked rotation positions of the rotatable plate.

13. The cooking appliance of claim 4, wherein the second heating plate is held stationary in the vertical position, and wherein the first heating plate is pivotably movable between an open generally horizontal position and a closed vertical position.

14. The cooking appliance of claim 13, further comprising a scale to which the first cooking plate and the second cooking plate are mounted, wherein the required amount of liquid based food in the cavity is measured by the scale in a real time dynamic manner.

15. The cooking appliance of claim 14, further comprising a lower stand having the scale, an upper stand vertically spaced above the lower stand via posts, wherein the liquid dispensing mechanism is disposed in the upper stand.

16. The cooking appliance of claim 15, wherein the liquid dispensing mechanism comprises a platform for receiving a bag having the liquid-based food therein, with an outlet nozzle of the bag being directed to an outlet of the dispensing mechanism, and
wherein the liquid dispensing mechanism comprises a roller which engages the bag for pushing out the liquid-based food into the upper inlet.

17. The cooking appliance of claim 13, wherein the cooking process is timed via a timer and when finished, the first cooking plate moves to the open position thereof with the cooked food product.

18. The cooking appliance of claim 14, further comprising: an optical sensor to detect a stream of the liquid-based food being dispensed and a control processor to alter the speed of dispensing as required.

19. The cooking appliance of claim 16, further comprising: a scale mounted under the platform for receiving the bag with the batter to measure how much batter is removed from the bag.

20. The cooking appliance of claim 1, further comprising: a proximity optical sensor to check the liquid level in the cooking cavity as it is being filled.

21. The cooking appliance of claim 1, wherein one of the first cooking plate or the second cooking plate has a higher cooking temperature than the other cooking plate.

22. The cooking appliance of claim 1 wherein one of the first cooking plate or the second cooking plate has a smaller cooking surface area than the other cooking plate.

23. (canceled)
